(19) United States
(12) Patent Application Publication
(10) Pub. No.: US 2018/0018716 A1
(43) Pub. Date: Jan. 18, 2018

(54) PRODUCT VALUATION TOOL

(71) Applicant: Chronofy, Inc., Miami, FL (US)

(72) Inventor: Joseph Akar, Miami, FL (US)

(73) Assignee: Chronofy, Inc., Miami, FL (US)

(21) Appl. No.: 15/210,561

(22) Filed: Jul. 14, 2016

(51) Int. Cl. G06Q 30/02

(52) U.S. Cl. CPC G06Q 30/0278

(57) ABSTRACT

A product valuation tool configured to facilitate evaluating a product. The product valuation tool includes a communications interface configured to facilitate communication with a user device and a processing circuit. The processing circuit is configured to receive a product indication from the user device regarding at least one of a brand and a model of the product, receive a condition indication from the user device regarding a condition of each component of the product, determine a monetary value for the product based on the condition indication for each component of the product, and provide a price quote interface on the user device displaying the monetary value for the product.

### BACKGROUND

Products such as jewelry (e.g., a ring, earrings, a bracelet, a necklace, a diamond, a pocket watch, a wristwatch, etc.), a vehicle (e.g., a car, a truck, a motorcycle, a boat, etc.), art (e.g., a painting, a sculpture, a photograph, a vase, etc.), sports memorabilia, an electronic device (e.g., a smartphone, a tablet, a smartwatch, a laptop, a game console, etc.) are often re-sold by the purchasers of such products. The valuation of such pre-owned products is often inconsistent due to subjective evaluation by or personal bias of the appraiser, and therefore the valuation of a product can vary greatly from person-to-person and transaction-to-transaction.

### SUMMARY

One embodiment relates to a product valuation tool configured to facilitate evaluating a product. The product valuation tool includes a product database, a product identification module, a product condition module, an aggregation module, and a product valuation module. The product database is configured to store various information for a product regarding at least one of a brand of the product, a model of the product, components of the product, a maximum value for the product, and a minimum value for the product. The product identification module is configured to provide a product identification interface on a user device and receive a product indication from the user device regarding at least one of the brand and the model. The product indication thereby indicates the product being evaluated. The product condition module is configured to provide a plurality of product condition interfaces on the user device. Each of the plurality of product condition interfaces displays various conditions of one of the components of the product. The product condition module is further configured to receive a condition indication from the user device regarding a condition of each of the components of the product, and determine point values for the condition of each of the components of the product based on the condition indication. The aggregation module is configured to aggregate the point values for each of the components of the product to determine an aggregated point value for the product. The product valuation module is configured to determine a monetary value for a single point based on the maximum value and the minimum value for the product, determine a total monetary value for the product based on at least one of the monetary value for the single point, the aggregated point value for the product, and the minimum value for the product, and provide a price quote interface on the user device displaying the total monetary value for the product.

Another embodiment relates to a method for valuing a product. The method includes storing, within memory of a valuation tool, various information for a product regarding at least one of a brand of the product, a model of the product, components of the product, a maximum value for the product, and a minimum value for the product; providing, by a processing circuit of the valuation tool, a product identification interface on a user device; receiving, by the processing circuit, a product indication from the user device regarding at least one of the brand and the model, the product indication thereby indicating the product being evaluated; providing, by the processing circuit, a plurality of product condition interfaces on the user device, each of the plurality of product condition interfaces displaying various conditions of one of the components of the product; receiving, by the processing circuit, a condition indication from the user device regarding a condition of each of the components of the product; determining, by the processing circuit, point values for the condition of each of the components of the product based on the condition indication; aggregating, by the processing circuit, the point values for each of the components of the product to determine an aggregated point value for the product; determining, by the processing circuit, a monetary value for the product based on the aggregated point value for the product; and providing, by the processing circuit, a price quote interface on the user device displaying the monetary value for the product.

Still another embodiment relates to a product valuation system configured to facilitate evaluating a product. The product valuation system includes a product valuation tool. The product valuation tool includes a communications interface configured to facilitate communication with a user device and a processing circuit. The processing circuit is configured to (i) receive a product indication from the user device regarding at least one of a brand and a model of the product, the product indication thereby indicating the product being evaluated, (ii) receive a condition indication from the user device regarding a condition of each component of the product, (iii) determine a monetary value for the product based on the condition indication for each component of the product, and (iv) provide a price quote interface on the user device displaying the monetary value for the product.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a product, according to an exemplary embodiment.

FIG. 2 is a schematic diagram of a product valuation system including a product valuation tool and a user device, according to an exemplary embodiment.

FIG. 3 is an illustration of a user login interface, according to an exemplary embodiment.

FIGS. 4A-4E are various illustrations of a product identification interface, according to an exemplary embodiment.

FIG. 5 is an illustration of a product documentation interface, according to an exemplary embodiment.

FIG. 6 is an illustration of a link condition interface, according to an exemplary embodiment.

FIG. 7 is an illustration of a bracelet condition interface, according to an exemplary embodiment.

FIG. 8 is an illustration of a watch-glass condition interface, according to an exemplary embodiment.

FIG. 9 is an illustration of a case and bezel condition interface, according to an exemplary embodiment.

FIG. 10 is an illustration of a price quote interface, according to an exemplary embodiment.

FIG. 11 is a flow diagram of a method for valuing a product based on various conditions of components of the product using various graphical user interfaces, according to an exemplary embodiment.

### DETAILED DESCRIPTION

Following below are more detailed descriptions of various concepts related to, and implementations of, methods, apparatuses, and systems for valuing a product based on various conditions of components of the product using various graphical user interfaces. The various concepts introduced above and discussed in greater detail below may be implemented in any of numerous ways, as the described concepts are not limited to any particular manner of implementation. Examples of specific implementations and applications are provided primarily for illustrative purposes. It should also be understood that the terminology is for the purpose of description only and should not be regarded as limiting.

According to an exemplary embodiment, a product valuation tool is configured to facilitate evaluating (e.g., appraising, valuating, etc.) a product (e.g., a watch, jewelry, a vehicle, art, an electronic device, sports memorabilia, etc.). Traditionally, the valuation of products (e.g., luxury watches, collectable cars, sports memorabilia, pre-owned items, etc.) is performed by experts who have been trained to do so. Store owners (e.g., jewelers, etc.) are often hesitant to value and/or purchase pre-owned products from clients due to lack of such training and the possibility of purchasing a fake product, overpaying for a product and losing money, and/or underpaying for a product and offending a potential or current client. Store owners often are thereby forced to turn away potential business and/or lose potential clients because of the inability to accurately and confidently value a pre-owned product. The product valuation tool of the present disclosure is configured to facilitate such evaluation without the need of such training. According to an exemplary embodiment, the product valuation tool is configured to provide various product condition interfaces on a user device that include visual representations and/or textual descriptions of conditions of various components of a product. The user may then select conditions provided by the product valuation tool that correspond with the actual condition of the product under evaluation (e.g., appraisal, valuation, etc.). The product valuation tool may then determine and provide a monetary value for the product according to current market pricing for the product based on the various selected conditions. Therefore, store owners may be able to provide accurate and fair offers to clients for their pre-owned products. According to an exemplary embodiment, the product valuation tool provides various advantages over traditional valuations of pre-owned products. By way of example, the product valuation tool may provide more accurate pricing relative to traditional valuation methods (e.g., a more objective pricing method compared to the subjective and/or biased evaluation of “trained experts,” etc.). By way of another example, the product valuation tool may provide decreased variation between evaluations of identical and/or similar products relative to traditional valuation methods.

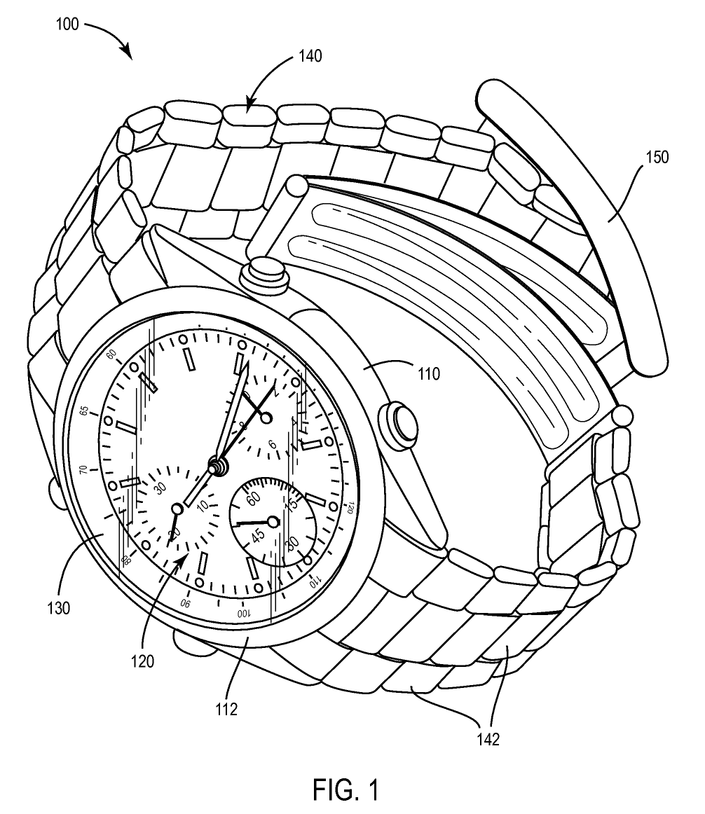

Referring to FIG. 1, a good, shown as product 100, is shown according to an exemplary embodiment. According to the exemplary embodiment shown in FIG. 1, the product 100 is a wristwatch. In other embodiments, the product 100 is and/or includes a different good. For example, the product 100 may be or include another type of jewelry (e.g., a ring, earrings, a bracelet, a necklace, a diamond, a pocket watch, etc.), a vehicle (e.g., a car, a truck, a motorcycle, a boat, etc.), art (e.g., a painting, a sculpture, a photograph, a vase, etc.), sports memorabilia, an electronic device (e.g., a smartphone, a tablet, a smartwatch, a laptop, a game console, etc.), and/or any other item or good that may be appraised (e.g., for a valuation, etc.).

As shown in FIG. 1, the product 100 includes a housing, shown as case 110, a bezel, shown as bezel 112, a face, shown as watch-face 120, a lens, shown as watch-glass 130, a band, shown as wristband 140, and a clasp, shown as buckle 150. The case 110 and/or bezel 112 may be manufactured from various materials including gold (e.g., white gold, yellow gold, rose gold, etc.), silver, platinum, titanium, aluminum, stainless steel, ceramic, wood, and/or other various materials. The watch-glass 130 may be manufactured from various materials including acrylic crystal, mineral crystal, sapphire crystal, and/or other transparent materials. According to the exemplary embodiment shown in FIG. 1, the wristband 140 includes a bracelet having a plurality of links, shown as links 142. The links 142 may be manufacture from various materials including gold (e.g., white gold, yellow gold, rose gold, etc.), silver, platinum, titanium, aluminum, stainless steel, ceramic, wood, and/or various other materials. In other embodiments, the wristband 140 includes a strap. The strap may be manufactured from various materials including leather, rubber (e.g., natural rubber, caoutchouc, synthetic rubber, etc.), textile, nylon, other natural materials, other synthetic materials, and/or various other materials. According to the exemplary embodiment shown in FIG. 1, the buckle 150 includes a deployment-type buckle. In other embodiments, the buckle 150 includes a tang-type buckle (e.g., similar to a belt buckle, etc.). In still other embodiments, the buckle 150 includes a different type of buckle (e.g., a magnetic buckle, a hook and loop buckle, etc.). The product 100 may additionally include various documentation (e.g., a manual, a certificate of authentication, a warranty, etc.) and/or a box.

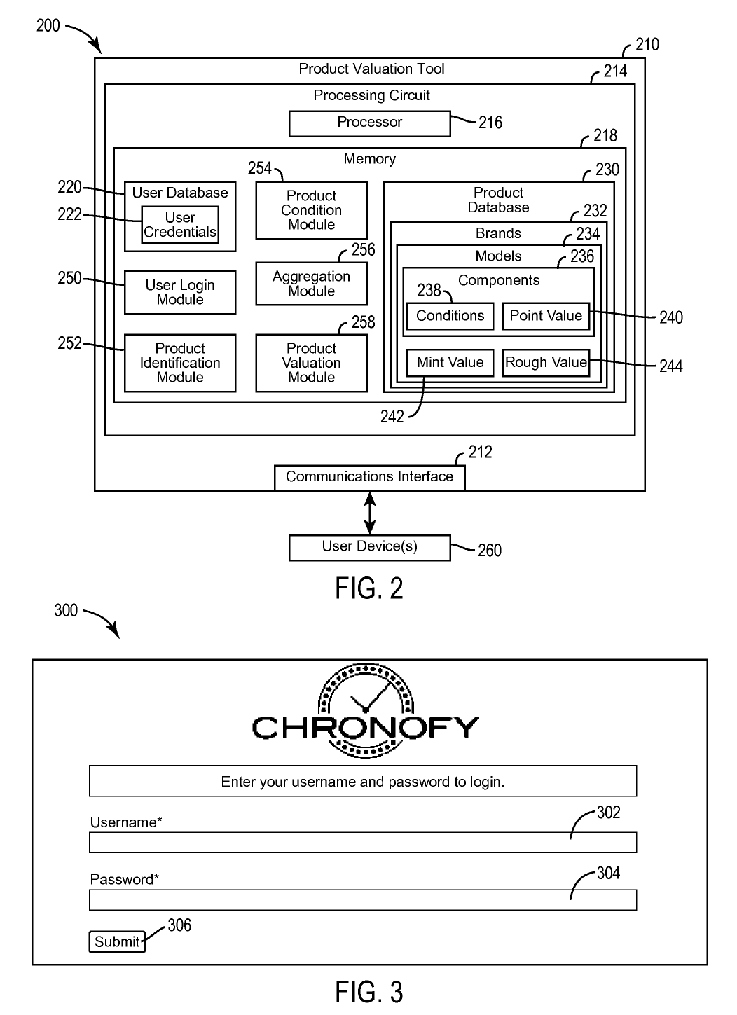

According to the exemplary embodiment shown in FIG. 2, a valuation system, shown as product valuation system 200, includes a valuation tool (e.g., a watch valuation tool, etc.), shown as product valuation tool 210, and one or more external devices, shown as user device(s) 260. According to an exemplary embodiment, product valuation system 200 is configured to facilitate evaluating (e.g., appraising, valuating, etc.) the product 100.

As shown in FIG. 2, the product valuation tool 210 includes a communications interface 212 and a processing circuit 214. The communication interface 212 may be configured to facilitate the communication between the user devices 260. The communication between the components of the product valuation tool 210 and the user devices 260 may be via any number of wired or wireless connections. For example, a wired connection may include a serial cable, a fiber optic cable, a CATS cable, or any other form of wired connection. In comparison, a wireless connection may include the Internet, Wi-Fi, cellular, radio, Bluetooth, ZigBee, etc. In one embodiment, a controller area network (CAN) bus provides the exchange of signals, information, and/or data. The CAN bus includes any number of wired and wireless connections.

According to an exemplary embodiment, the user device 260 is configured to establish a connection with the communications interface 212 and provide a variety of information to the product valuation tool 210. The user device 260 may provide the variety of information to the product valuation tool 210 responsive to a user input (e.g., on a graphical user interface, etc.). The user device 260 may include a display screen, a touch screen, one or more buttons, a touch pad, a mouse, and/or other devices to allow a user to operate the user device 260 and/or provide the user input to the product valuation tool 210. According to an exemplary embodiment, the user device 260 includes a display that is configured to provide various graphical user interfaces (e.g., a user login interface, a product identification interface, a product documentation interface, a link condition interface, a bracelet condition interface, a watch-glass condition interface, a case and bezel condition interface, a price quote interface, etc.) to the user of the product valuation system 200. In some embodiments, the user device 260 includes portable devices. The portable devices may include, but is not limited to, a smartphone, a tablet, a laptop, a smartwatch, and/or any other type of portable device. In some embodiments, the user device 260 includes stationary devices (e.g., a desktop computer, etc.).

As shown in FIG. 2, the processing circuit 214 includes a processor 216 and a memory 218. The processor 216 may be implemented as a general-purpose processor, an application specific integrated circuit (ASIC), one or more field programmable gate arrays (FPGAs), a digital signal processor (DSP), a group of processing components, or other suitable electronic processing components. The memory 218 (e.g., RAM, ROM, Flash Memory, hard disk storage, etc.) may store data and/or computer code for facilitating the various processes described herein. Thus, the memory 218 may be communicably connected to the processor 216 and provide computer code or instructions to the processor 216 for executing the processes described in regard to the product valuation system 200 described herein. Moreover, the memory 218 may be or include tangible, non-transient volatile memory or non-volatile memory. In some embodiments, the memory 218 may include database components, object code components, script components, or any other type of information structure for supporting the various activities and information structures described herein.

The memory 218 is shown to include various databases and modules for completing processes described herein. More particularly, the memory 218 includes databases and modules configured to value a product based on various conditions of components of the product received from various graphical user interfaces and provide a price quote for the product (e.g., based on a multi-factor weighted analysis, etc.) to a user of the product valuation system 200. While various databases and modules with particular functionality are shown in FIG. 2, it will be understood that the product valuation tool 210 and the memory 218 may include any number of databases and/or modules for completing the functions described herein. For example, the activities of multiple databases and/or modules may be combined as a single database and/or module and additional databases and/or modules with additional functionality may be included. Further, it will be understood that the processing circuit 214 of the product valuation tool 210 may further control other processes beyond the scope of the present disclosure.

As shown in FIG. 2, the memory 218 of the product valuation tool 210 includes a user database 220 and a product database 230. The memory 218 of the product valuation tool 210 further includes a user login module 250, a product identification module 252, a product condition module 254, an aggregation module 256, and a product valuation module 258.

The user database 220 may be configured to store user credentials 222 for each registered user of the product valuation system 200 (e.g., a user with a registered account, etc.). The user credentials 222 may include a username, a login ID, an account number, an email address, a password, etc. for each registered user. The product database 230 may be configured to store various information for the product 100. The product database 230 and the product valuation tool 210 are described herein in association with a wristwatch, however it should be understood that the product database 230 may store information regarding any type of product (e.g., jewelry, vehicles, art, electronics, sports memorabilia, etc.) and that the product valuation tool 210 may facilitate evaluating any such product.

As shown in FIG. 2, the various information for the product 100 that may be stored by the product database 230 includes at least one of brands 232 of the product 100 (e.g., Brand X, Rolex, Cartier, Tag Heuer, Movida, Breitling, Patek Philippe, etc.), models 234 and/or submodels of the product 100 (e.g., Model Y, Datejust, Milgauss, Explorer, Submariner, etc.), components 236 of the product 100 (e.g., the case 110, the bezel 112, the watch-face 120, the watch-glass 130, the wristband 140, the buckle 150, a manual, a certificate of authentication, a warranty, a box, etc.), a maximum value or mint value 242 for the product 100 based on current market pricing, a minimum value or rough value 244 for the product 100 based on current market pricing, and a reference number (e.g., a model number, a product number, a serial number, etc.) for the product 100, among other possible information regarding the product 100.

As shown in FIG. 2, the product database 230 may include possible conditions 238 (e.g., mint, above average, average, rough, etc.) for each component 236 of the product 100 and a point value 240 associated with each of the conditions 238 of the components 236 and/or the components 236 included with the product 100. The various conditions 238 of each component 236 of the product 100 may be weighted differently such that (i) a component having a mint condition has a higher point value 240 than the same component having a rough condition (e.g., twenty points for a component in mint condition, ten points for the same component in an average condition, five point for the same component in a rough condition, etc.) and/or (ii) a more desirable and/or more expensive component has a higher point value 240 than a less desirable and/or less expensive component (e.g., ten points for a deployment-type buckle, five points for a tang-type buckle, etc.). The components 236 of the product 100 may have varying maximum possible point values 240 relative to one another (e.g., the case 110 and bezel 112 may have a first maximum point value of thirty-five points, while the watch-glass 130 may have a second maximum point value of five points, etc.).

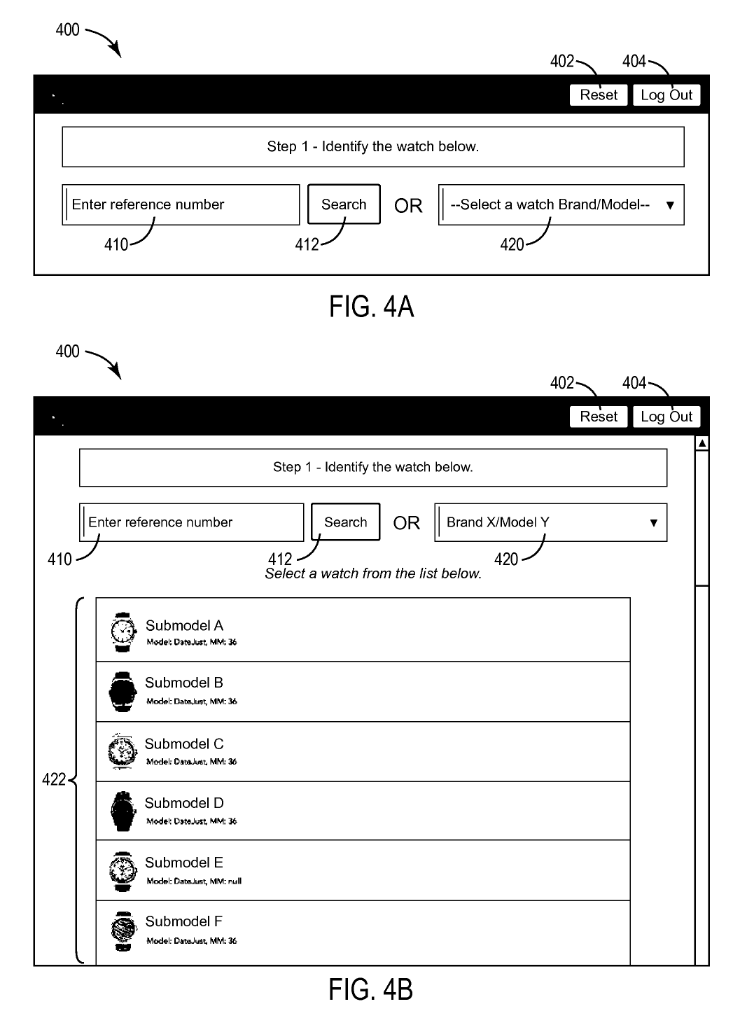

The user login module 250 may be communicably coupled to the communications interface 212 and the user database 220. According to an exemplary embodiment, the user login module 250 is configured to provide a user login interface on the user device 260 (e.g., see FIG. 3, etc.). The user login interface may be configured to facilitate receiving the user credentials 222 from a user of the product valuation system 200 via the user device 260 and/or facilitate a new user signing up for an account by providing unique credentials. The user login module 250 may be configured to access the user database 220 to verify the that user credentials 222 received from the user device 260 are associated with a valid/registered user account and/or the new credentials are unique. The user login module 250 may thereby be configured to grant or deny a respective user device 260 access to the product valuation tool 210 based on whether the user credentials 222 provided by a user of a user device 260 correspond with a registered account. If the user credentials 222 are not valid, the user login module 250 may provide a request to the user on the user device 260 to register for an account (e.g., set up an account to establish user credentials 222, etc.) and/or to re-enter the user credentials 222.

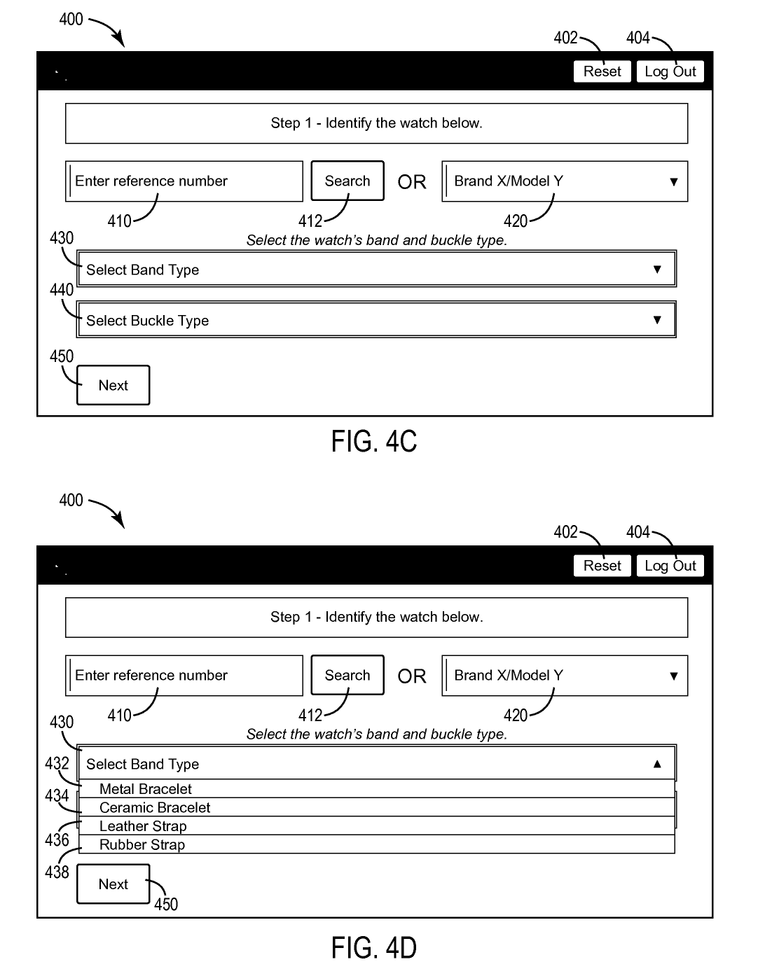

The product identification module 252 may be communicably coupled to the communications interface 212, the product database 230, and/or the product condition module 254. According to an exemplary embodiment, the product identification module 252 is configured to provide a product identification interface on the user device 260 (e.g., see FIGS. 4A-4E, etc.). The product identification interface may be configured to receive a product indication from a user of the product valuation system 200 via the user device 260. The product indication may include information regarding at least one of the brand 232, the model 234, the submodel, and/or various other identifying characteristics (e.g., the type of buckle 150, the type of wristband 140, etc.) of the product 100. The product identification module 252 may be configured to access the product database 230 to determine the product 100 based on the product indication. The product indication may thereby indicate the product 100 desired to be evaluated (e.g., valued, appraised, etc.) by a respective user of the product valuation system 200.

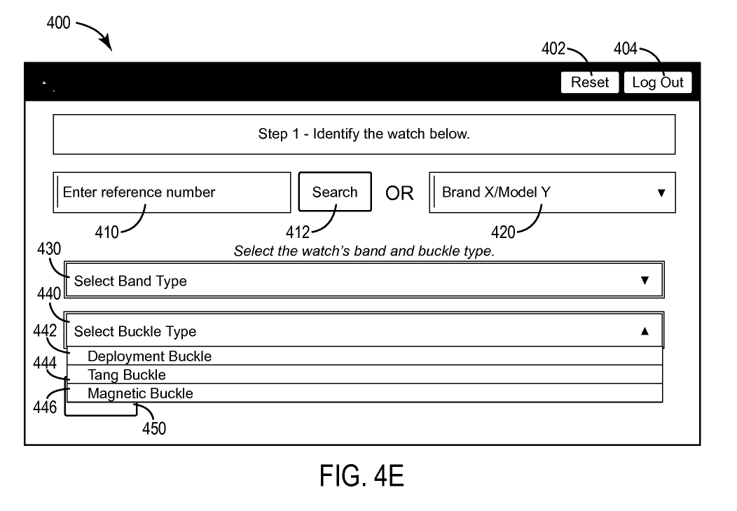

The product condition module 254 may be communicably coupled to the communications interface 212, the product database 230, the product identification module 252, and/or the aggregation module 256. According to an exemplary embodiment, the product condition module 254 is configured to provide a plurality of product condition interfaces on the user device 260 (e.g., see FIGS. 5-9, etc.). Each of the plurality of product condition interfaces may display various possible conditions 238 of one of the components 236 of the product 100. The product condition module 254 may thereby access the product database 230 to receive the conditions 238 associated with the components 236 of the product 100 being evaluated (e.g., determined by the product identification module 252, etc.) for display to the user on the user device 260. By way of example, a first product condition interface may display a mint condition first component (e.g., like-new, no scratches and/or blemishes, etc.), an above average condition first component (e.g., minor scratches and/or blemishes, no damage, etc.), an average condition first component (e.g., scratches and/or blemishes from normal use, etc.), a rough condition first component (e.g., major scratches and/or blemishes, noticeable damage, etc.), etc. of the product 100 and a second product condition interface may display a mint condition second component, an above average condition second component, an average condition second component, a rough condition second component, etc. of the product 100. In some embodiments, the product condition module 254 is configured to provide user selectable widgets on each product condition interface that visually depict the various conditions 238 of a respective component 236 of the product 100 being evaluated. In some embodiments, the product condition module 254 is configured to additionally or alternatively provide user selectable widgets on each product condition interface that textually depict the various conditions 238 of the respective component 236 of the product 100 being evaluated.

The product condition module 254 may be configured to receive a condition indication from a user with the user device 260 regarding a condition 238 of each of the components 236 of the product 100. The product condition module 254 may be configured to access the product database 230 to determine the point value 240 associated with the condition 238 of each of the components 236 of the product 100 based on the respective condition indications (e.g., between a minimum point value for a rough condition and a maximum value for a mint condition, etc.). By way of example, the product condition module 254 may receive a first condition indication regarding a condition of a first component of the product 100, a second condition indication regarding a condition of a second component, etc. The product condition module 254 may then be configured to determine a first point value for the first component based on the indicated condition thereof, a second point value for the second component based on the indicated condition thereof, etc.

The aggregation module 256 may be communicably coupled to the product condition module 254 and/or the product valuation module 258. The aggregation module 256 may be configured to aggregate the point values 240 for each of the components 236 of the product 100 (e.g., determined by the product condition module 254, etc.) to determine an aggregated point value for the product 100. By way of example, the aggregation module 256 may sum a first point value for a first component, a second point value for a second component, a third point value for a third component, etc. of the product 100 to determine a total aggregate point value for the product 100.

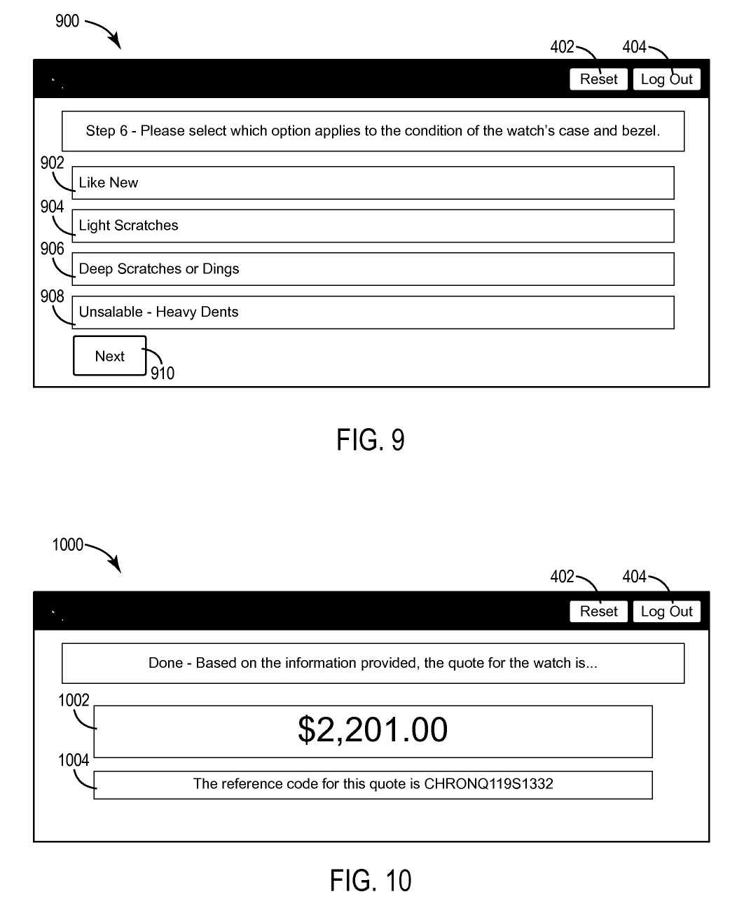

The product valuation module 258 may be communicably coupled to the communications interface 212, the product database 230, the product identification module 252, and/or the aggregation module 256. According to an exemplary embodiment, the product valuation module 258 is configured to determine a valuation (e.g., a monetary value, etc.) for the product 100 based on the aggregated point value for the product 100 (e.g., determined by the aggregation module 256, a multi-factor weighted analysis, etc.). The product valuation module 258 may provide a price quote interface on the user device 260 (e.g., see FIG. 10, etc.) displaying the valuation for the product 100.

The product valuation module 258 may determine a monetary value for the product 100 based on the mint value 242, the rough value 244, the aggregated point value, and/or a total number of possible points for the product 100. The product valuation module 258 may thereby access the product database 230 to determine the mint value 242 and the rough value 244 for the product 100 under evaluation (e.g., determined by the product identification module 252, etc.). By way of example, the product valuation module 258 may determine the monetary value for the product 100 as follows. First, the product valuation module 258 may determine a difference between the mint value 242 and the rough value 244 of the product 100. The difference may be represented by the following expression:

ΔV=Vₘᵢₙₜ−V_{rough} (1)

where Vₘᵢₙₜ is the mint value 242 of the product 100, V_{rough} is the rough value 244 of the product 100, and ΔV is the difference between the mint value 242 and the rough value 244.

Second, the product valuation module 258 may determine a value for a single point based on (i) the difference between the mint value 242 and the rough value 244 and (ii) a total number of possible points for the product 100. According to an exemplary embodiment, the total number of possible points for the product 100 is one hundred points. In other embodiments, the total number of possible points for the product 100 is a different value (e.g., fifty point, ninety points, one hundred and ten points, one hundred and thirty points, etc.). The total number of possible points may be uniform for all products and/or vary based on the respective product (e.g., some products may include more components that others, some products may include components having higher point values, etc.). The value for a single point may be represented by the following expression:

$${V}_{point} = \frac{Δ V}{{P}_{possible}} \qquad ( 2 )$$

where P_{possible} is the possible number of points for the product 100 and Vₚₒᵢₙₜ is the value per point.

Third, the product valuation module 258 may determine a subtotal for the product 100 based on the aggregated point value for the product 100 and the value for the single point. The subtotal may be represented by the following expression:

V_{subtotal}=Vₚₒᵢₙₜ·P_{aggregate} (3)

where P_{aggregate} is the aggregated total number of points for the product 100 (e.g., determined by the product condition module 254 and the aggregation module 256, etc.) and V_{subtotal} is the subtotal for the product 100.

Fourth, the product valuation module 258 may determine a total monetary value for the product 100 based on the rough value 244 and the subtotal. The total monetary value may be represented by the following expression:

Vₜₒₜₐₗ=V_{subtotal}+V_{rough} (4)

where Vₜₒₜₐₗ is the total monetary value determined for the product 100 by the product valuation module 258 based on the mint value 242 (Vₘᵢₙₜ), the rough value 244 (V_{rough}), the aggregated point value (P_{aggregate}), and the total number of possible points (P_{possible}) for the product 100, which may be encompassed by the following expression:

$${V}_{total} = \frac{( {V}_{mint} - {V}_{rough} ) \cdot {P}_{aggregate}}{{P}_{possible}} + {V}_{rough} \qquad ( 5 )$$

According to an alternative embodiment, the product valuation system 200 includes a scanning device. The scanning device may be configured to scan the product 100 desired to be valued such that the product valuation tool 210 may analyze the condition of the components 236 (e.g., the case 110, the bezel 112, the watch-glass 130, the wristband 140, the buckle 150, etc.) based on condition data acquired by the scanning device (e.g., with minimal or no user input, etc.) to determine a value for the product 100. Such a product valuation system 200 may further (i) decrease variation between evaluations of identical and/or similar products relative to traditional valuation methods and/or (ii) provide more accurate pricing relative to traditional valuation methods.

Referring now to Table 1, two examples of the valuation of a product having various components 236 (e.g., the case 110, the bezel 112, the watch-face 120, the watch-glass 130, the wristband 140, the buckle 150, the manual, the certificate of authentication, the box, etc.) based on the conditions 238 thereof are shown. According to Table 1, the first product 100 (e.g., a watch having a bracelet type wristband 140, etc.) (i) includes a box, a certificate of authentication, and a manual (ten out of ten points), (ii) has a case 110 and a bezel 112 with light scratches (twenty-five out of thirty-five points), (iii) has a watch-glass 130 with light scratches or dings (three out of five points), (iv) has a bracelet type wristband 140 in a normal condition (twenty-five out of thirty-five points), and (v) is missing one link 142 (twelve out of fifteen points),. Therefore, the aggregate points for the first product 100 is seventy-five points and the total possible points for the first product 100 is one hundred points. According to Table 1, the first product 100 has a mint value 242 of $10,000.00 and a rough value 244 of $4,000.00. The difference between the mint value 242 and the rough value 244 is $6000.00, the value per point is approximately $60.00, the subtotal is $4,500.00, and the total value is $8,500.00.

According to Table 1, the second product 100 (e.g., a watch having a leather strap type wristband 140, etc.) (i) includes a box, a certificate of authentication, and a manual (ten out of ten points), (ii) has a case 110 and a bezel 112 with light scratches (twenty-five out of thirty-five points), (iii) has a watch-glass 130 with light scratches or dings (three out of five points), (iv) has a strap type wristband 140 in a normal condition (twenty-five out of thirty-five points), and (v) has a tang-type buckle 150 (five points). Therefore, the aggregate points for the second product 100 is sixty-eight points and the total possible points for the second product 100 is ninety points. According to Table 1, the second product 100 has a mint value 242 of $8,000.00 and a rough value 244 of $3,000.00. The difference between the mint value 242 and the rough value 244 is $5000.00, the value per point is approximately $55.56, the subtotal is $3,777.78, and the total value is $6,777.78. It should be understood that the two examples provided are for illustrative purposes only and should not be regarded as limiting.

TABLE 1
Examples for Various Conditions of Components of Various Products

| Components | Conditions | Point | Product #1 | Product #2 |
|---|---|---|---|---|
| 236 | 238 | Value 240 | (Bracelet) | (Strap) |
| Documentation | Box | 7 | 10/10 | 10/10 |
| and | Certificate | 2 | | |
| Packaging | Manual | 1 | | |
| Case 110 | Like New | 35 | 25/35 | 25/35 |
| and | Light Scratches | 25 | | |
| Bezel 112 | Deep Scratches | 10 | | |
| | or Dings | | | |
| | Unsalable—Heavy | 0 | | |
| | Dents | | | |
| Watch-Glass | Like New | 5 | 3/5 | 3/5 |
| 130 | Light Scratches | 3 | | |
| | or Dings | | | |
| | Heavy Scratches | 0 | | |
| | or Dings | | | |
| Band 140 | Like New | 35 | N/A | 25/35 |
| (Strap) | Normal | 25 | | |
| | Poor | 5 | | |
| Band 140 | Like New | 35 | 25/35 | N/A |
| (Bracelet) | Normal | 25 | | |
| | Slack | 10 | | |
| | Loose | 5 | | |
| Links 142 | Maximum | 15 | 12/15 | N/A |
| | Number | | | |
| | Missing one | 12 | | |
| | Missing two | 9 | | |
| | Missing three | 6 | | |
| | Missing four | 3 | | |
| | Missing five or | 0 | | |
| | more | | | |
| Buckle 150 | Deployment | 10 | N/A | 5 |
| | Tang | 5 | | |

| | | |
|---|---|---|
| Aggregated Points | 75 | 68 |
| Possible Points | 100 | 90 |
| Mint Value 242 | $10,000.00 | $8,000.00 |
| Rough Value 244 | $4,000.00 | $3,000.00 |
| Total Monetary Value | $8,500.00 | $6,777.78 |

According to the exemplary embodiments shown in FIGS. 3-10, various user interfaces that may be provided to a user of the product valuation system 200 on a display of the user device 260 are illustrated. Referring now to FIG. 3, the product valuation tool 210 may provide a login interface, shown as user login interface 300, to a user of the product valuation system 200 on the user device 260. As shown in FIG. 3, the user login interface 300 includes a first fillable section, shown as username section 302, a second fillable section, shown as password section 304, and a button, shown as submit button 306. According to an exemplary embodiment, the username section 302 and the password section 304 are configured to receive the user credentials 222 of a user of the product valuation system 200. The user may select the submit button 306 to enter the user credentials 222 for verification (e.g., by the user login module 250 and the user database 220, etc.).

Referring now to FIGS. 4A-4E, the product valuation tool 210 may provide a product identification interface, shown as product identification interface 400, to a user of the product valuation system 200 on the user device 260. The product identification interface 400 may be configured to facilitate a user of the product valuation system 200 entering a product indication via the user device 260 into the product valuation tool 210. As shown in FIGS. 4A-4E, the product identification interface 400 includes a first button, shown as reset button 402, a second button, shown as log out button 404, a fillable section, shown as reference number section 410, a third button, shown as search button 412, and a drop-down list, shown as brand/model list 420. The reset button 402 may be configured to facilitate clearing any information entered into the various sections of the product identification interface 400. The log out button 404 may be configured to facilitate logging out of the product valuation tool 210. The reference number section 410 may facilitate entering a reference number (e.g., a model number, a product number, a serial number, a reference code, etc.) for the product 100 desired to be appraised and the search button 412 may facilitate searching the product database 230 for a product 100 that matches the reference number.

The brand/model list 420 may facilitate selecting the brand 232 and/or the model 234 of the product 100 desired to be appraised. As shown in FIG. 4B, selecting the brand 232 and/or the model 234 of the product 100 causes the product valuation tool 210 to display a submodel section, shown as submodel list 422, on the product identification interface 400. The submodel list 422 provides various submodels associated the product 100 selected via the brand/model list 420. The user may select one of the submodels within the submodel list 422.

As shown in FIG. 4C, selecting the submodel of the product 100 from the submodel list 422 causes the product valuation tool 210 to display a band type section, shown as band list 430, and a buckle type section, shown as buckle list 440. The band list 430 may include various wristbands 140 (e.g., bracelets, straps, etc.) associated with the selected product 100 (e.g., based on the brand 232, the model 234, the submodel, etc.). The buckle list 440 may include various buckles 150 (e.g., deployment, tang, etc.) associated with the selected product 100 (e.g., based on the brand 232, the model 234, the submodel, etc.). As shown in FIG. 4D, the band list 430 provides a first band type, shown as metal bracelet 432 (e.g., gold, platinum, silver, stainless steel, titanium, etc.), a second band type, shown as ceramic bracelet 434, a third band type, shown as leather strap 436, and a fourth band type, shown as rubber strap 438, each being associated with the selected product 100. The band list 430 may include fewer, greater, and/or different band types (e.g., two band types, five band types, a textile strap, a wood bracelet, etc.) in other embodiments (e.g., based on the brand 232, the model 234, and/or the submodel chosen, etc.). As shown in FIG. 4E, the buckle list 440 provides a first buckle type, shown as deployment buckle 442, a second buckle type, shown as tang buckle 444, and a third buckle type, shown as magnetic buckle 446, each being associated with the selected product 100. The buckle list 440 may include fewer, greater, and/or different buckle types (e.g., two buckle types, four buckle types, a hook and loop buckle, etc.) in other embodiments (e.g., based on the brand 232, the model 234, and/or the submodel chosen, etc.). As shown in FIGS. 4A-4C and 4E, the product identification interface 400 includes a fourth button, shown as next button 450. The next button 450 may be configured to facilitate moving to another user interface (e.g., a product documentation interface, etc.).

Referring now to FIG. 5, the product valuation tool 210 may provide a product documentation interface, shown as product documentation interface 500, to a user of the product valuation system 200 on the user device 260. The product documentation interface 500 may be configured to facilitate a user of the product valuation system 200 inputting various information about the box, the manual, and/or the certificate for the product 100. As shown in FIG. 5, the product documentation interface 500 includes a first user selectable widget, shown as box widget 502, a second user selectable widget, shown as certificate widget 504, a third user selectable widget, shown as manual widget 506, and a fourth user selectable widget, shown as watch widget 508. The box widget 502, the certificate widget 504, the manual widget 506, and/or the watch widget 508 may visually and/or textually depict the various items that may be included with the product 100. Each of the box widget 502, the certificate widget 504, the manual widget 506, and/or the watch widget 508 may be individually selected by a user to provide an indication of which are included with the product 100 to the product valuation tool 210. As shown in FIG. 5, the product documentation interface 500 includes a button, shown as next button 510. The next button 510 may be configured to facilitate moving to another user interface (e.g., a link condition interface, a band condition interface, etc.).

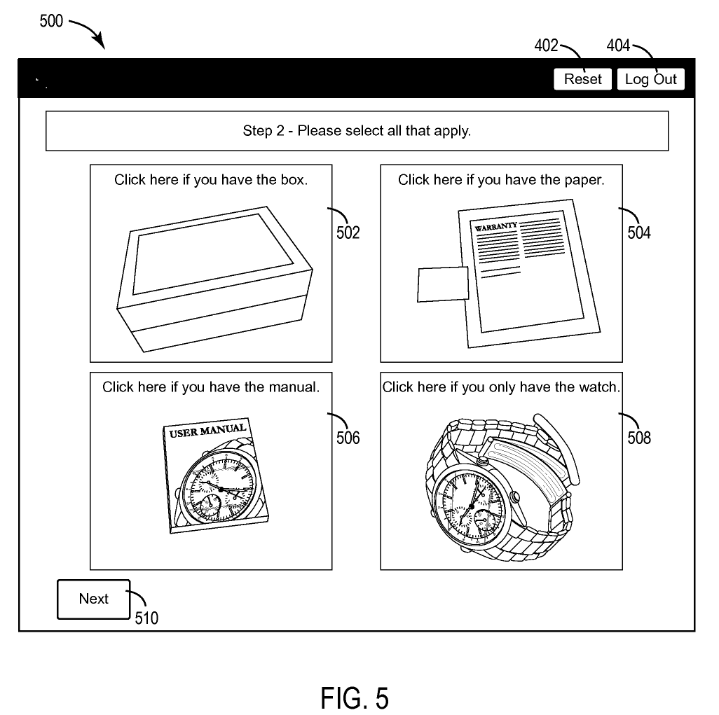

Referring now to FIG. 6, the product valuation tool 210 may provide a link condition interface, shown as link condition interface 600, to a user of the product valuation system 200 on the user device 260. The link condition interface 600 may be configured to facilitate a user of the product valuation system 200 indicating how many links 142 are included within the wristband 140 (e.g., if the product 100 includes a bracelet type wristband 140 having links 142, etc.). The link condition interface 600 may be omitted if the wristband 140 of the selected product 100 is a strap type or other non-bracelet type wristband 140. As shown in FIG. 6, the link condition interface 600 includes various user selectable widgets 602-608 that visually and/or textually depict the number of links 142 included with the wristband 140 of the product 100. One of the user selectable widgets 602-608 may be selected by a user to provide an indication of the number of links 142 included with the wristband 140 of the product 100 to the product valuation tool 210. As shown in FIG. 6, the link condition interface 600 includes a button, shown as next button 610. The next button 610 may be configured to facilitate moving to another user interface (e.g., a band condition interface, etc.).

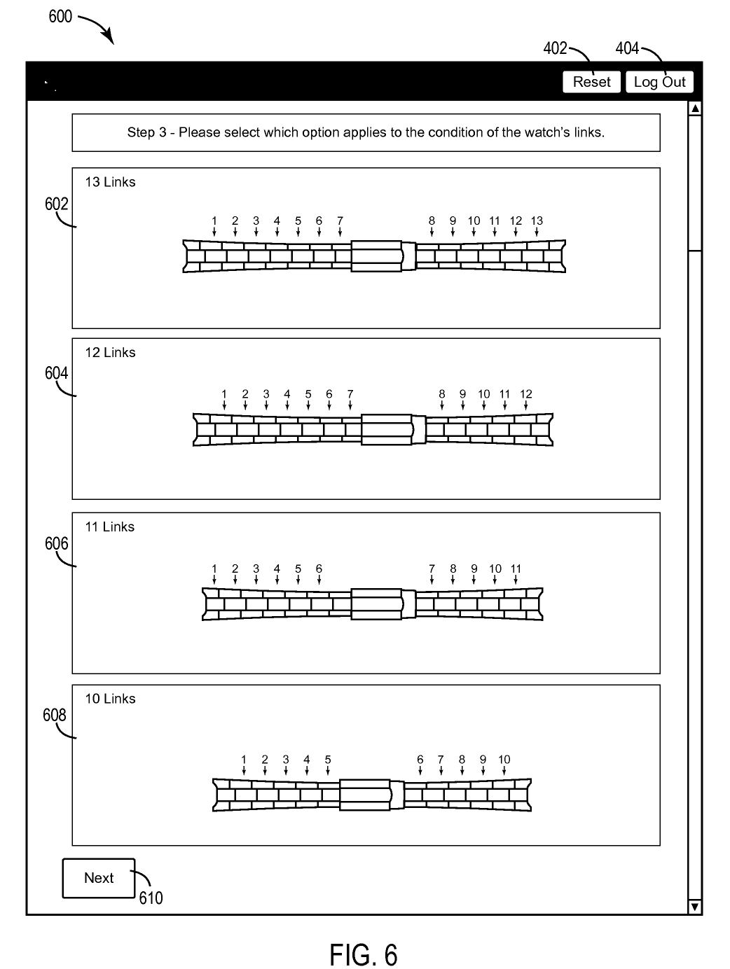

Referring now to FIG. 7, the product valuation tool 210 may provide a band condition interface, shown as band condition interface 700, to a user of the product valuation system 200 on the user device 260. The band condition interface 700 may be configured to facilitate a user of the product valuation system 200 indicating a condition (e.g., like new, normal, slack, loose, etc.) of the wristband 140 of the product 100. According to the exemplary embodiment shown in FIG. 7, the band condition interface 700 is configured to facilitate evaluating a bracelet type wristband 140 (e.g., a wristband 140 having links 142, in response to a bracelet type wristband being selected on the product identification interface 400, etc.). As shown in FIG. 7, the band condition interface 700 includes a first user selectable widget, shown as like new widget 702, a second user selectable widget, shown as normal widget 704, a third user selectable widget, shown as slack widget 706, and a fourth user selectable widget, shown as loose widget 708. The like new widget 702, the normal widget 704, the slack widget 706, and/or the loose widget 708 may visually and/or textually depict various conditions of the wristband 140 of the product 100. One of the like new widget 702, the normal widget 704, the slack widget 706, and the loose widget 708 may be selected by a user to provide an indication of the condition of the wristband 140 of the product 100 to the product valuation tool 210. As shown in FIG. 7, the band condition interface 700 includes a button, shown as next button 710. The next button 710 may be configured to facilitate moving to another user interface (e.g., a watch-glass condition interface, etc.).

In other embodiments, the band condition interface 700 is configured to facilitate evaluating a strap type wristband 140 (e.g., a leather strap, in response to a strap type wristband being selected on the product identification interface 400, etc.). In such embodiments, the band condition interface 700 may provide a plurality of user selectable widgets that visually and/or textually depict various conditions of the strap (e.g., a leather strap, etc.) of the wristband 140 of the product 100. By way of example, the band condition interface 700 may include a like new widget, an average/normal widget (e.g., minor cracks in the leather, etc.), and/or a poor widget (e.g., major cracks and/or rips in the leather, etc.) that depict the condition of the strap type wristband 140. The band condition interface 700 may further facilitate evaluating the condition of the buckle 150 of the strap type wristband 140. By way of example, the band condition interface 700 may provide may provide an option to select whether the buckle 150 is a tang type or a deployment type. The band condition interface 700 may additionally provide a plurality of user selectable widgets that visually and/or textually depict various conditions of the buckle 150 (e.g., like new, average, poor, etc.).

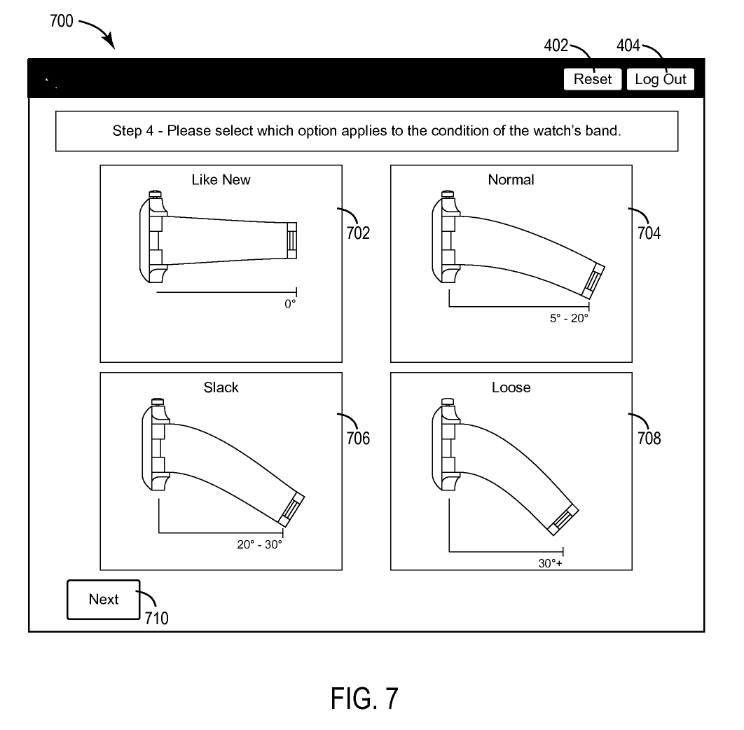

Referring now to FIG. 8, the product valuation tool 210 may provide a lens condition interface, shown as watch-glass condition interface 800, to a user of the product valuation system 200 on the user device 260. The watch-glass condition interface 800 may be configured to facilitate a user of the product valuation system 200 indicating a condition (e.g., like new, light scratches, heavy scratches, etc.) of the watch-glass 130 of the product 100. As shown in FIG. 8, the watch-glass condition interface 800 includes a first user selectable widget, shown as like new widget 802, a second user selectable widget, shown as light damage widget 804 (i.e., light scratches and/or dings), and a third user selectable widget, shown as heavy damage widget 806 (i.e., heavy scratches and/or dings, very visible damage). The like new widget 802, the light damage widget 804, and/or the heavy damage widget 806 may visually and/or textually depict various conditions of the watch-glass 130 of the product 100. One of the like new widget 802, the light damage widget 804, and the heavy damage widget 806 may be selected by a user to provide an indication of the condition of the watch-glass 130 of the product 100 to the product valuation tool 210. As shown in FIG. 8, the watch-glass condition interface 800 includes a button, shown as next button 810. The next button 810 may be configured to facilitate moving to another user interface (e.g., a case and bezel condition interface, etc.).

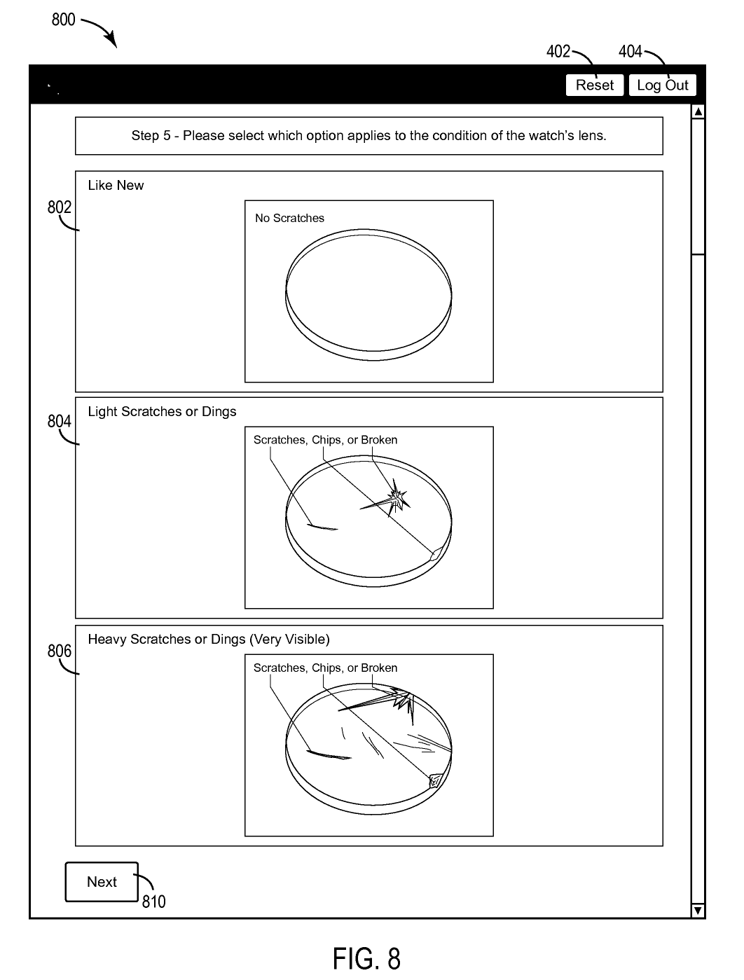

Referring now to FIG. 9, the product valuation tool 210 may provide a case and bezel condition interface, shown as case and bezel condition interface 900, to a user of the product valuation system 200 on the user device 260. The case and bezel condition interface 900 may be configured to facilitate a user of the product valuation system 200 indicating a condition (e.g., like new, light scratches, deep scratches, heavy dents, etc.) of the case 110 and/or the bezel 112 of the product 100. As shown in FIG. 9, the case and bezel condition interface 900 includes a first user selectable widget, shown as like new widget 902, a second user selectable widget, shown as light scratches widget 904, a third user selectable widget, shown as deep scratches or dings widget 906, and a fourth user selectable widget, shown as heavy dents widget 908. The like new widget 902, the light scratches widget 904, the deep scratches or dings widget 906, and/or the heavy dents widget 908 may visually and/or textually depict various conditions of the case 110 and/or the bezel 112 of the product 100. One of the like new widget 902, the light scratches widget 904, the deep scratches or dings widget 906, and the heavy dents widget 908 may be selected by a user to provide an indication of the condition of the case 110 and/or the bezel 112 of the product 100 to the product valuation tool 210. As shown in FIG. 9, the case and bezel condition interface 900 includes a button, shown as next button 910. The next button 910 may be configured to facilitate moving to another user interface (e.g., a price quote interface, etc.).

Referring now to FIG. 10, the product valuation tool 210 may provide a valuation interface, shown as price quote interface 1000, to a user of the product valuation system 200 on the user device 260. The price quote interface 1000 may be configured to facilitate providing the appraised value (e.g., the total monetary value, the valuation, etc.) of the product 100 to the user of the product valuation system 200 on the user device 260 (e.g., based on the various conditions 238 of the product 100 indicated using interfaces 400-900, etc.). As shown in FIG. 10, the price quote interface 1000 includes a price quote section, shown as product valuation 1002, which displays the appraised value of the product 100 and a reference section, shown as valuation reference 1004, which displays a reference code for the valuation of the product 100. The reference code may facilitate accessing the price quote at a future time (e.g., by entering the reference code into the reference number section 410, etc.).

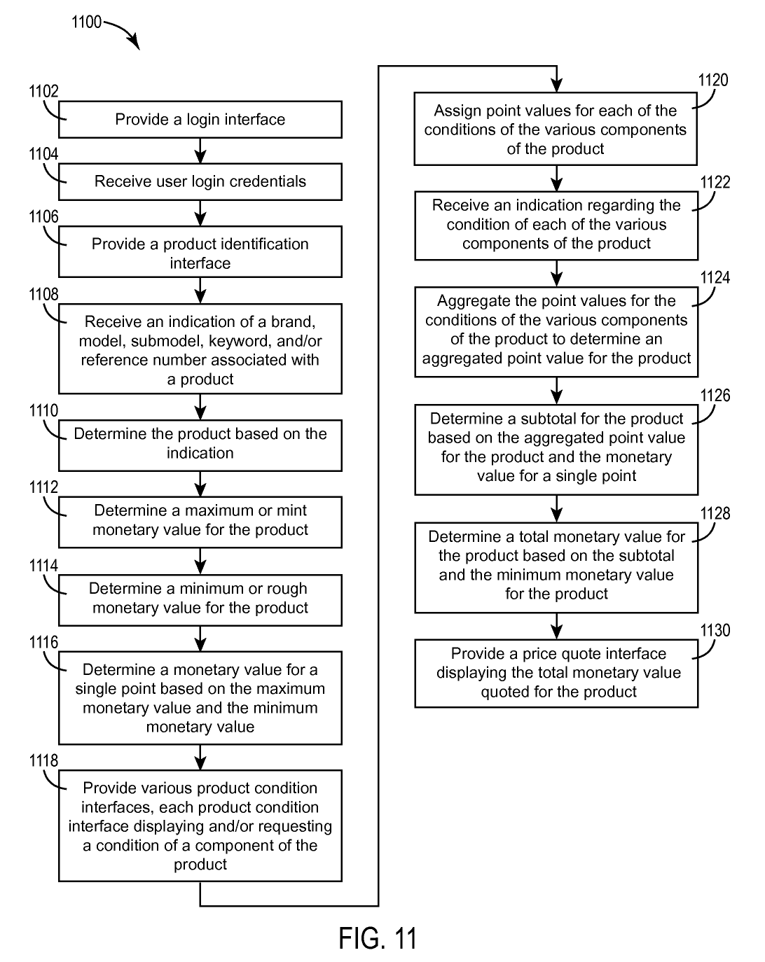

Referring now to FIG. 11, a method 1100 for valuing a product based on various conditions of components of the product using various graphical user interfaces is shown according to an exemplary embodiment. In one example embodiment, method 1100 may be implemented with the product valuation tool 210 and the user device 260 of product valuation system 200 of FIG. 2, as well as the various graphical user interfaces of FIGS. 3-10. Accordingly, method 1100 may be described in regard to FIGS. 2-10.

At step 1102, the product valuation tool 210 is configured to provide a login interface (e.g., the user login interface 300, etc.) on a user interface of a user device (e.g., the user device 260, etc.). At step 1104, the product valuation tool 210 is configured to receive user login credentials (e.g., the user credentials 222, etc.) from a user with the user device. At step 1106, the product valuation tool 210 is configured to provide a product identification interface (e.g., the product identification interface 400, etc.) on the user interface of the user device. At step 1108, the product valuation tool 210 is configured to receive an indication of a brand, a model, a submodel, a keyword, and/or a reference number associated with a product (e.g., the product 100, etc.) from the user with the user device. The product valuation tool 210 may be further configured to receive additional information (e.g., a buckle type, a band type, etc.) from the user with the user device.

At step 1110, the product valuation tool 210 is configured to determine the product based on the indication. At step 1112, the product valuation tool 210 is configured to determine a maximum or mint monetary value (e.g., the mint value 242, etc.) for the product. At step 1114, the product valuation tool 210 is configured to determine a minimum or rough monetary value (e.g., the rough value 244, etc.) for the product. At step 1116, the product valuation tool 210 is configured to determine a monetary value for a single point based on the maximum monetary value and the minimum monetary value of the product.

At step 1118, the product valuation tool 210 is configured to provide various product condition interfaces (e.g., interfaces 500-900, etc.) on the user interface of the user device. According to an exemplary embodiment, each product condition interface displays and/or requests a condition (e.g., the conditions 238, etc.) of a component (e.g., the components 236, etc.) of the product. At step 1120, the product valuation tool 210 is configured to assign point values (e.g., the point values 240, etc.) for each of the conditions of the various component of the product. At step 1122, the product valuation tool 210 is configured to receive an indication regarding the condition of each of the various components of the product from the user with the user device. At step 1124, the product valuation tool 210 is configured to aggregate the point values for the conditions of the various components of the product to determine an aggregated point value for the product.

At step 1126, the product valuation tool 210 is configured to determine a subtotal for the product based on the aggregated point value for the product and the monetary value for a single point. At step 1128, the product valuation tool 210 is configured to determine a total monetary value for the product based on the subtotal and the minimum monetary value of the product. At step 1130, the product valuation tool 210 is configured to provide a price quote interface (e.g., the price quote interface 1000, etc.) displaying the total monetary value quoted for the product on the user interface of the user device.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, flash memory, solid state devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A product valuation tool configured to facilitate evaluating a product, the product valuation tool, comprising:
a product database configured to store various information for a product regarding at least one of a brand of the product, a model of the product, components of the product, a maximum value for the product, and a minimum value for the product;
a product identification module configured to:
provide a product identification interface on a user device; and
receive a product indication from the user device regarding at least one of the brand and the model, the product indication thereby indicating the product being evaluated;
a product condition module configured to:
provide a plurality of product condition interfaces on the user device, each of the plurality of product condition interfaces displaying various conditions of one of the components of the product;
receive a condition indication from the user device regarding a condition of each of the components of the product; and
determine point values for the condition of each of the components of the product based on the condition indication;
an aggregation module configured to aggregate the point values for each of the components of the product to determine an aggregated point value for the product; and
a product valuation module configured to:
determine a monetary value for a single point based on the maximum value and the minimum value for the product;
determine a total monetary value for the product based on at least one of the monetary value for the single point, the aggregated point value for the product, and the minimum value for the product; and
provide a price quote interface on the user device displaying the total monetary value for the product.

2. The product valuation tool of claim 1, further comprising a communications interface configured to facilitate communication with the user device.

3. The product valuation tool of claim 1, wherein determining the monetary value for the single point includes (i) determining a difference between the maximum value and the minimum value, and (ii) dividing the difference by a total number of possible points for the product.

4. The product valuation tool of claim 3, wherein determining the total monetary value for the product includes (i) multiplying the aggregated point value for the product by the monetary value for the single point to determine a subtotal for the product, and (ii) adding the subtotal and the minimum value for the product.

5. The product valuation tool of claim 1, wherein the components of the product have varying maximum possible point values relative to one another.

6. The product valuation tool of claim 5, wherein the various conditions of the one of the components of the product are weighted differently such that a component having a mint condition has a higher point value than the component having a rough condition.

7. The product valuation tool of claim 5, wherein the product includes a watch and the components include at least one of a case, a bezel, a band, a buckle, and a lens.

8. The product valuation tool of claim 1, wherein at least one of the plurality of product condition interfaces provides user selectable widgets that visually depict the various conditions of a component of the product being evaluated.

9. The product valuation tool of claim 1, wherein at least one of the plurality of product condition interfaces provides user selectable widgets that textually depict the various conditions of a component of the product being evaluated.

10. A method for valuing a product, comprising:
storing, within memory of a valuation tool, various information for a product regarding at least one of a brand of the product, a model of the product, components of the product, a maximum value for the product, and a minimum value for the product;
providing, by a processing circuit of the valuation tool, a product identification interface on a user device;
receiving, by the processing circuit, a product indication from the user device regarding at least one of the brand and the model, the product indication thereby indicating the product being evaluated;
providing, by the processing circuit, a plurality of product condition interfaces on the user device, each of the plurality of product condition interfaces displaying various conditions of one of the components of the product;
receiving, by the processing circuit, a condition indication from the user device regarding a condition of each of the components of the product;
determining, by the processing circuit, point values for the condition of each of the components of the product based on the condition indication;
aggregating, by the processing circuit, the point values for each of the components of the product to determine an aggregated point value for the product;
determining, by the processing circuit, a monetary value for the product based on the aggregated point value for the product; and
providing, by the processing circuit, a price quote interface on the user device displaying the monetary value for the product.

11. The method of claim 10, wherein at least one of the plurality of product condition interfaces provides user selectable widgets that visually depict the various conditions of a component of the product being evaluated.

12. The method of claim 10, wherein at least one of the plurality of product condition interfaces provides user selectable widgets that textually depict the various conditions of a component of the product being evaluated.

13. The method of claim 10, wherein the various conditions of the one of the components of the product are weighted differently such that a component having a mint condition has a higher point value than the component having a rough condition.

14. The method of claim 13, wherein the components of the product have varying maximum possible point values relative to one another.

15. A product valuation system configured to facilitate evaluating a product, comprising:
a product valuation tool including:
a communications interface configured to facilitate communication with a user device; and
a processing circuit configured to:
receive a product indication from the user device regarding at least one of a brand and a model of the product, the product indication thereby indicating the product being evaluated;
receive a condition indication from the user device regarding a condition of each component of the product;
determine a monetary value for the product based on the condition indication for each component of the product; and
provide a price quote interface on the user device displaying the monetary value for the product.

16. The product valuation system of claim 15, wherein the product valuation tool further includes a memory configured to store various information for the product regarding at least one of the brand of the product, the model of the product, the components of the product, a maximum value for the product, and a minimum value for the product.

17. The product valuation system of claim 15, wherein determining the monetary value for the product includes:
determining a point value for the condition of each component of the product based on the condition indication;
aggregating the point values for each of the components of the product to determine an aggregated point value for the product;
determining a difference between a maximum value and a minimum value of the product;
determining a value for a single point based on the difference and a total number of possible points for the product;
determining a subtotal for the product based on the aggregated point value for the product and the value for the single point; and
determining the monetary value for the product based on the minimum value and the subtotal.

18. The product valuation system of claim 15, wherein the processing circuit is further configured to provide a plurality of product condition interfaces on the user device, each of the plurality of product condition interfaces displaying various conditions of one component of the product.

19. The product valuation system of claim 18, wherein at least one of the plurality of product condition interfaces provides user selectable widgets that at least one of textually and visually depict the various conditions of a respective component of the product being evaluated.

20. The product valuation system of claim 18, wherein the various conditions of the one component of the product are weighted differently such that a component having a mint condition has a higher point value than the component having a rough condition, and wherein the components of the product have varying maximum possible point values.
